(19) United States
(12) Patent Application Publication
(10) Pub. No.: US 2005/0258681 A1
(43) Pub. Date: Nov. 24, 2005

(54) Brake with calibration and diagnostics and method and program product related thereto

(75) Inventors: Gary C. Fulks, Centerville, OH (US); Michael C. Pfeil, South Charleston, OH (US)

Correspondence Address: Michael D. Smith, Mail Code: 480-410-202, P.O. Box 5052, Troy, MI, 48007, US

(73) Assignee: Delphi Technologies, Inc., Troy, MI (US)

(21) Appl. No.: 10/849,969

(22) Filed: May 20, 2004

(51) Int. Cl. B60T 13/74

(52) U.S. Cl. 303/3

(57) ABSTRACT

A method and program product are associated with a brake mechanism. The brake mechanism includes a brake operable to restrict movement of a vehicle and an actuator coupled to the brake. The actuator is operable to selectively apply and release the brake. The mechanism further includes a controller coupled to the actuator. A method, implemented in the controller and program code, initializes the brake mechanism and calibrates and/or performs diagnostics on the brake mechanism.

### FIELD OF THE INVENTION

The present invention relates to brake system, and more particularly, to method, apparatus, and program product for controlling a parking brake.

### BACKGROUND OF THE INVENTION

Most vehicle designs incorporate parking brakes. Typical parking brake configurations continuously employ regular drum brakes on a rear wheel. Parking brakes commonly rely on simple mechanical linkage to engage the brakes. The driver may simply pull a lever which is coupled to a brake cable which actuates the brakes. To release the brake, a button is pressed while lifting and releasing the lever. For these types of parking brakes, there may be a relatively large amount of “play” in the brake cable, i.e., a relatively large range of motion of the lever and brake cable may be required in order to supply sufficient braking force to retain the vehicle in place. This is generally satisfactory, since the drive may simply lift the lever until sufficient force has been applied.

However, in some systems, the parking brake is engaged electronically. The driver may simply depress a pedal, lever, button or other suitable means, which sends a signal to a controller or actuator which engages the brake.

In these type of systems, since the brake is automatically actuated, it is important to know when a target force is being applied to the wheel(s), such that the vehicle is retained in its current position. Some systems accomplish this by using a force sensor which measure the force being applied by the brake. The brake or brake actuator may therefore be controlled using closed loop forced feedback.

However, such sensors add cost to the system. And harsh environmental factors, such as temperature variation and moisture, reduce the reliability and accuracy of the sensors. Additional circuitry may be used to compensate for the drift and sensitivity variations caused by the factors, however, this again adds cost and complexity to the system.

The present invention is aimed at one or more of the problems identified above.

### SUMMARY OF THE INVENTION

In a first aspect of the present invention, a method for calibrating a brake mechanism having a brake coupled to an actuator is provided. The actuator includes a motor and is controlled through rotations of the motor. The motor includes the steps of initializing the brake mechanism, applying a predetermined power level to the actuator, establishing motor stall and responsively determining a reference motor position, and establishing a home motor position as a function of the second position and a predetermined constant.

In a second aspect of the present invention, a brake mechanism, is provided. The brake mechanism includes a brake operable to restrict movement of a vehicle and an actuator coupled to the brake. The actuator is operable to selectively apply and release the brake. The mechanism further includes a controller coupled to the actuator. The controller is operable to initialize the brake mechanism and apply a predetermined power level to the actuator, to establish motor stall and responsively determine a reference motor position, and to establish a home motor position as a function of the second position and a predetermined constant.

In a third aspect of the present invention, a program product for calibrating a brake mechanism having a brake coupled to an actuator is provided. The actuator includes a motor and is controlled through rotations of the motor. The program product includes program code means for initializing the brake mechanism, for applying a predetermined power level to the actuator, for establishing motor stall and responsively determining a reference motor position, and for establishing a home motor position as a function of the second position and a predetermined constant.

In a fourth aspect of the present invention, a method for providing diagnostics for a brake mechanism having a brake coupled to an actuator is provided. The actuator has a motor and is controlled through rotations of the motor. The method includes the steps of establishing a current motor position, incrementing power to the motor to achieve a target position, and determining the power required to move motor to the target position when the motor has reached the target position. The method also includes the step of determining if the required power is outside of a predetermined range.

In a fifth aspect of the present invention, a brake mechanism is provided. The brake mechanism includes a brake operable to restrict movement of a vehicle and an actuator, having a motor, coupled to the brake. The actuator is operable to selectively apply and release the brake. The mechanism also includes a controller coupled to the actuator and being operable to establish a current motor position, increment power to the motor to achieve a target position, and determine power required to incrementally move the motor has and to determine if the required power is outside of a predetermined range.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a block diagram that illustrates a brake system environment consistent with the principles of the present invention.

FIG. 2 is a graph representing forces incident on the actuator of FIG. 1 versus displacement of the actuator.

FIG. 3A is a first portion of a flowchart that embodies steps suited for implementation within the brake system environment of FIG. 1.

FIG. 3B is a second portion of the flowchart of FIG. 3A.

FIG. 4 is a second graph representing forces incident on the actuator of FIG. 1 versus distance of the actuator.

FIG. 5A is a first portion of a second flowchart that embodies steps suited for implementation within the brake system environment of FIG. 1.

FIG. 5B is a second portion of the flowchart of FIG. 5A.

### DETAILED DESCRIPTION

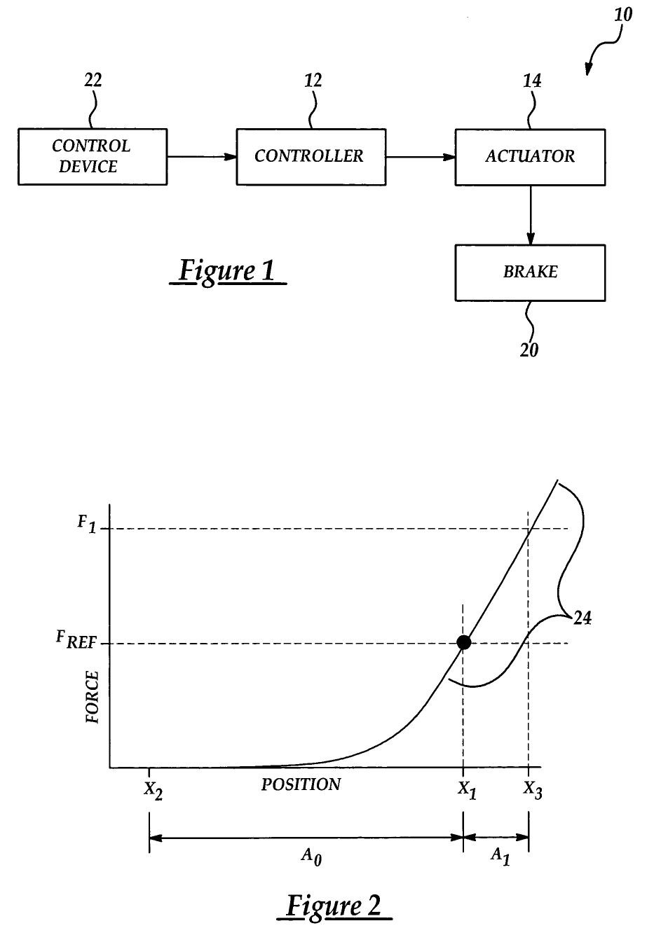

The block diagram of FIG. 1 illustrates a brake mechanism 10 that is consistent with the principles of the present invention. The brake system 10 employs position control functions to regulate the actuation and release of a brake 20, such as a parking brake. Generally, a controller 12 may execute a combined load/position algorithm configured to control the movement of an actuator 14. The actuator 14 is coupled to the brake 20 and may be configured to selectively actuate and release brake 20 in response to a command or command signals. The brake 20 is operable to restrict movement of a vehicle (not shown). As such, the travel of the actuator 14 causes a force to be transferred to the brake 20.

The algorithm controlling the movement of the actuator 14 includes calibration and diagnostic routines which may account for variations within the brake mechanism 10 and for determining when a target load is being applied by the brake 20.

In one embodiment, the brake 20 is a disc brake which is directly coupled to the actuator 14. As such, the travel of the actuator 14 causes a force to be transferred directly to the brake 20.

In another embodiment, the brake 20 is a drum brake. The actuator 14 is connected to a brake cable (not shown). The brake cable, in turn, is coupled to the brake 20 via a brake lever (not shown). In one embodiment, the brake lever is operable to actuate the drum brakes/calipers of, for example, the rear brake 20 of a vehicle (not shown). The brake is operable to restrict movement of the vehicle. As such, the travel of the actuator 14 causes a force to be transferred to the brake lever via the cable.

An operator may initiate actuation or release of the brake 20 through actuation of a control device 22, such as a button and/or lever. The control device 22 may transmit an actuation and/or release signal to the controller 12. The controller 12 may include a computer, central processing unit, microprocessor or other suitable control device.

In general, the controller 12, in response to the actuation and/or release signal, may initiate processing of a position feedback control program (or program product) resident in the controller 12. The program may instruct the controller 12 to transmit a command to a motor in the actuator 14. In addition to the motor, the actuator 14 may incorporate a position sensor, a power screw and a gear set (not shown) for gaining mechanical advantage. In response to the command, the actuator 14 may travel in directions along an axis of the actuator 14. Alternatively, it will be appreciated that movement of the actuator 14 may occur in any direction corresponding to an increase or decrease of brake force. This movement of the actuator 14 is accomplished according to a position feedback control program.

In the illustrated embodiment, the position feedback control program requires is based on a home position, i.e., the zero force or drag position, at which no force is exerted by the brake 20. In one aspect of the present invention, the controller 12 implements a calibration routine under power-up, e.g., when the vehicle's engine is started. The calibration routine is aimed at determining the zero force or drag position of the actuator 14. In the illustrated embodiment, this zero force position is defined in terms of a (rotary) motor position within the actuator 14. For example, the rotary motor position may be defined in terms of turns (counts) of the motor.

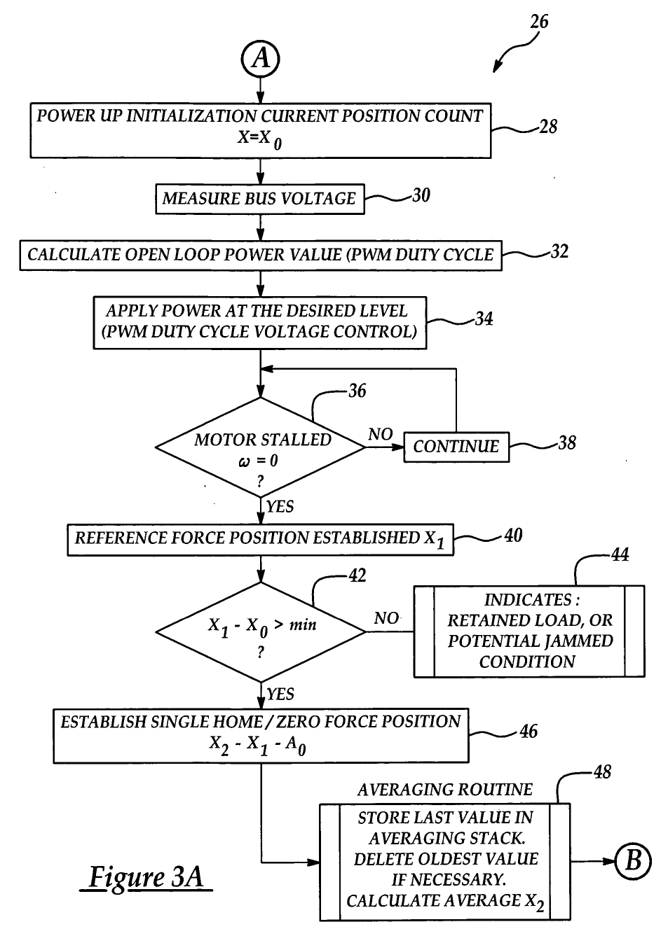

With reference to FIG. 2, an exemplary force/displacement curve for illustrating operation of the calibration routine is shown. The zero force position is labeled X₂. The two forces, F_{REF} and F₁, are within the linear force/displacement region 24 of the actuator 14. F_{REF} and F₁ are predetermined values. In one embodiment, F_{REF} is defined as the force at which the motor will stall, i.e., rotational velocity equal to zero and F₁ is the defined as approximately the force required to hold the vehicle on a 20% grade.

Generally, the calibration routine determines the home motor position (X2) as a position or count of the motor by establishing the motor position at which the actuator 14 exerts a force equal to F_{REF} and then, using the known nominal characteristics of the actuator 14, establishing X₂.

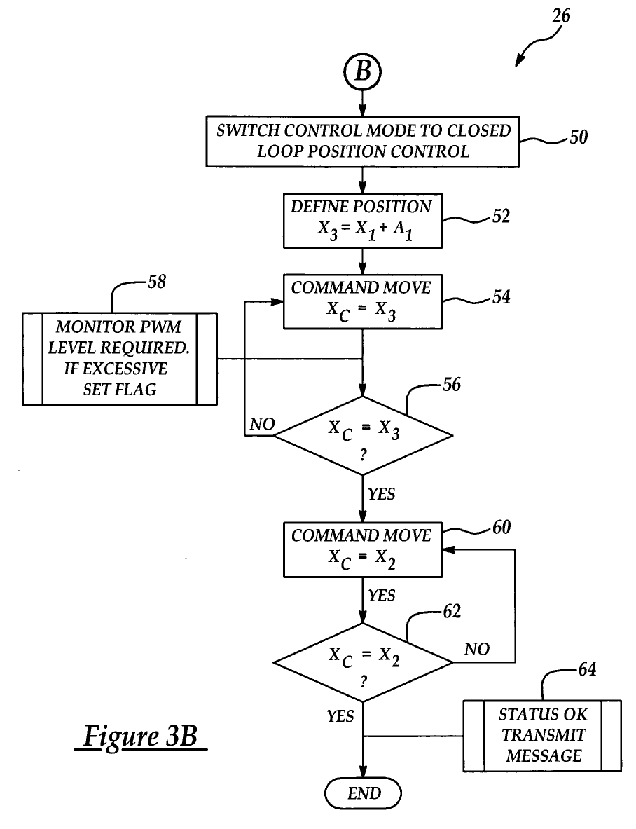

With particular reference to FIGS. 3A and 3B, a method 26 for calibrating and providing start-up diagnostics for the brake mechanism 10 according to an embodiment of the present invention is shown. In a first step 26, the brake mechanism 10 is initialized and an initial position (X₀), i.e., count, of the motor is established.

Next, a predetermined power level is applied to the actuator 14. In the illustrated embodiment, the actuator 14 is controlled via a pulse width modulated (PWM) signal in a conventional manner. The actual power applied to the actuator 14 will be controlled by the duty cycle of the PWM signal and the supply or bus voltage. Thus, in a second step 30, the bus voltage is measured. Based on the measured bus voltage, an open loop power value, i.e., PWM duty cycle, is calculated in a third step 32 to achieve the predetermined power level. In a fourth step 34, the power is applied to the actuator 14 through application of the PWM signal to the motor.

Then, motor stall is established. In a first decision block 36, if the motor has stalled, i.e., rotation velocity equals zero (as established via the position sensor), then control proceeds to a fifth step 40. If motor stall has not been established control proceeds back to the first decision block 36 via sixth step 38.

Once motor stall has been established, the reference position X₁ is determined in the fifth step 40.

In another aspect of the present invention, the method 26 may perform a diagnostic as a function of X₁ to determine if the brake mechanism 10 has a retained load. In a second decision block 40, the difference between the initial position (X₀) and the reference motor position (X₁) is compared with a predetermined minimum value (min). If the difference is less than or equal to the predetermined minimum value, then a signal may be generated in a seventh step 44, e.g., a flag may be set and/or an indicator light may be turned on. The signal may be indicative of a retained load.

In an eighth step 46, the home motor position is established as a function of the second position (X₁) and a predetermined constant (A₀) by the equation:
X₂=X₁−A₀.

The predetermined constant, A₀, is determined as a function of the nominal characteristics of the brake mechanism 10 and is expressed in turns or counts of the motor.

In one embodiment of the present invention, in a ninth step 49 a predetermined number of home position values may be stored, e.g., in a stack, and averaged to determine an average home position value. This average home position value may be used in the position feedback control algorithm used to control the parking brake mechanism 10 in response to user actuation of the control device 22. After the home position (X₂) has calculated, another diagnostic test may be performed. In a tenth step 50, the controller 12 switches to closed loop position control. In an eleventh step 52, a target position or target motor position (X₃), which in the illustrated embodiment corresponds to F₁, is determined as a function of at least one of the reference position and the home motor position and a second predetermined constant (A₁). For example, the target position, X₃, may be determined by the equation:
X₃=X₁+A₁, where A₁ is a determined as a function of the nominal characteristics of the brake mechanism 10.

In a twelfth step 54, command signals are generated to the motor to move to the target position. As discussed above, in the illustrated embodiment, the command signals are PWM signals. In a third decision block 56, if the target position has not been achieved, control returns to the twelfth step 54. Otherwise, control proceeds to a thirteenth step 60.

During the loop defined by the twelfth step 54 and the third decision block 56, the command signals, i.e., the PWM signal levels required to move the motor from X₃, are monitored, and if excessive, an error signal is generated.

Once, the target position has been reached, commands signals are generated to the motor to move to the home position, X₂ in the thirteenth step 60. In a fourth decision block 62, if the home position has not been achieved, control returns to the thirteenth step 60. Otherwise, control proceeds to a fourteenth step 64. In the fourteenth step 64, a confirmation signal is generated.

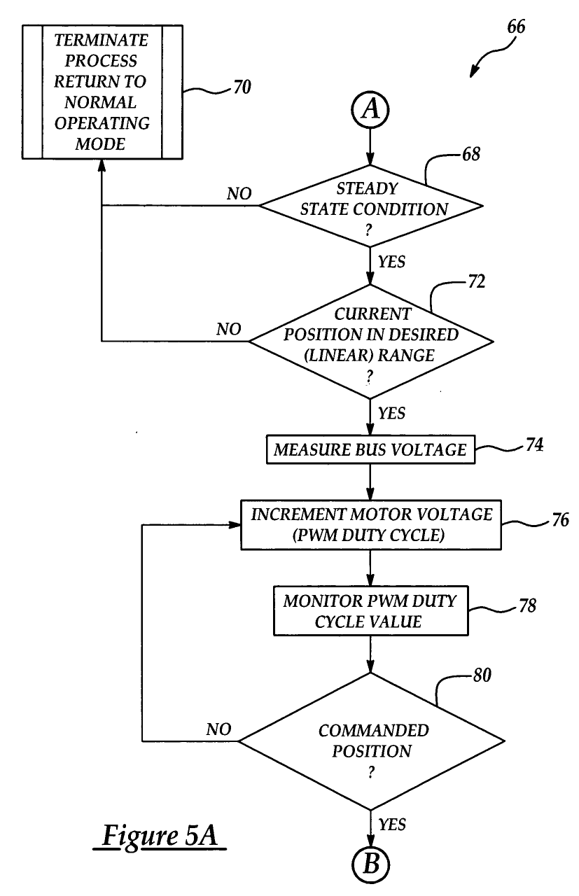

In another aspect of the present invention, a steady-state diagnostic algorithm may be provided. With reference FIGS. 5A and 5B, the steady-state diagnostic algorithm or method 66 is implemented only when the brake mechanism 10 is in a steady-state condition.

In a decision block 68, if a steady-state condition does not exist the method 66 proceeds to a first step 70 and returns to the normal operating mode. In one embodiment of the present invention, a steady-state condition is defined by either a zero position error or zero velocity of the motor.

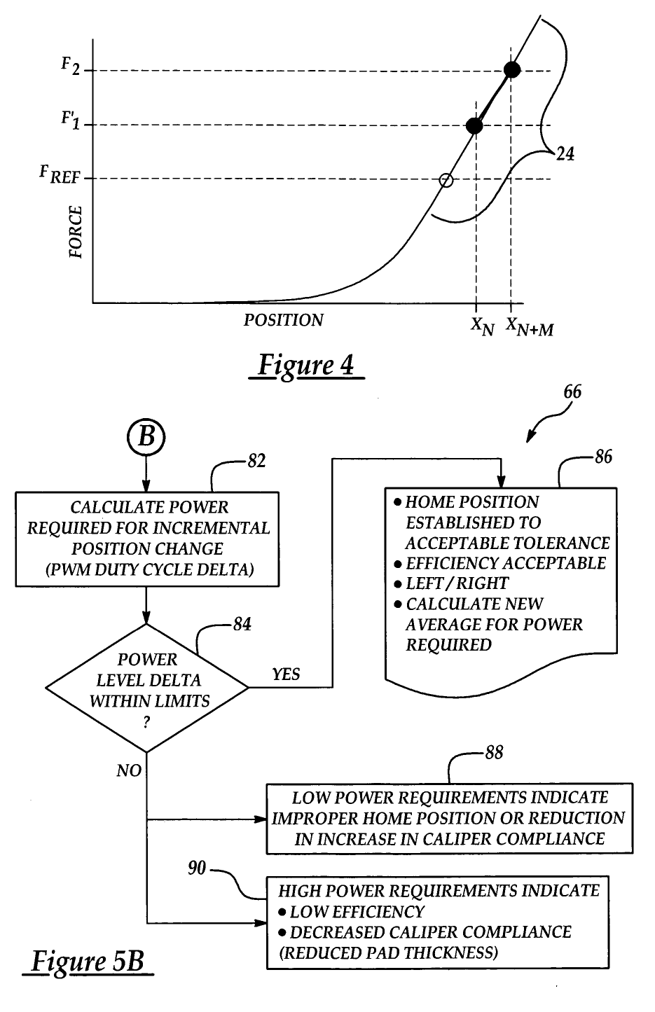

If the steady-state condition exists, the method 66 proceeds to a second decision block 72. With reference to FIG. 4, the current motor position is established using the position sensor and, if the current position (X_{N}) of the motor/actuator 14 is within the linear operating range 24 of the actuator 14, then the method proceeds to a second step 74. F′₁ is the force corresponding to the X_{N} on the force/position curve. Otherwise, the method 66 proceeds to the first step 70.

In the second step 74, the bus or supply voltage to the motor is measured and, in a second step, the command signals to the motor are incremented to increase power to the motor to achieve a target position (X_{N+M}). In one embodiment, as discussed above, the command signals are in the form of PWM signals.

In one embodiment, the target position X_{N+M} is calculated using the equation: X_{N+M}=X_{N}+M, where M is a number of turns of the motor, e.g., one.

In a fourth step 78, the duty cycle of the PWM command signals are monitored. In a third decision block 80, if the commanded or target position has not been reached, then control returns to the third step 76. Otherwise, the method 66 proceeds to a fifth step 82. In the fifth step 82, the power required to move motor to the target position is calculated based on the change in the duty cycle of the PWM command signals.

In a fourth decision block 82, if the calculated required power (to move from X_{N} to X_{N+M}) is within a predetermined power range, then control proceeds to a sixth step 86. If the calculated required power is within the predetermined power range, i.e., is acceptable, this may be indicative of an acceptable home position (see above), acceptable efficiency within the brake mechanism 10.

If the required power is outside the predetermined power range, then the method proceeds to either of seventh step 88 or an eighth step 90. In the seventh step 88, the required power is below the predetermined power range which may be indicative of an improper home position (see above) or other actuator non-compliance. In the eighth step 90, the required power is above the predetermined power range which may be indicative of a low efficiency in the brake mechanism 10 and/or decreased actuator compliance, due, for example, to reduced brake pad thickness.

Obviously, many modifications and variations of the present invention are possible in light of the above teachings. The invention may be practiced otherwise than as specifically described within the scope of the appended claims.

1. A method for calibrating a brake mechanism having an actuator, the actuator having a motor and being controlled through rotations of the motor, comprising:
initializing the brake mechanism;
applying a predetermined power level to the actuator;
establishing motor stall and responsively determining a reference motor position; and,
establishing a home motor position as a function of the second position and a predetermined constant.

2. A method, as set forth in claim 1, further comprising establishing an initial motor position at initialization.

3. A method, as set forth in claim 2, further comprising:
comparing a difference between the initial position and the reference motor position and a predetermined minimum value; and,
generating a signal if the difference is less than or equal to the predetermined minimum value.

4. A method, as set forth in claim 3, the signal being indicative of a retained load condition

5. A method, as set forth in claim 1, further comprising:
storing a predetermined number of previous home position values; and, calculating an average home position.

6. A method, as set forth in claim 1, the method further comprising:
defining a target motor position to deliver a predetermined force through the brake as a function of at least one of the reference position and the home motor position and a second predetermined constant;
generating command signals to the motor to move to the target position;
monitoring the command signals, and if excessive, generating an error signal; and,
after the target position has been reached, generating commands signals to the motor to move to the home position.

7. A method, as set forth in claim 6, further comprising the step of generating a confirmation signal when the home position has been reached.

8. A brake mechanism, comprising:
a brake operable to restrict movement of a vehicle;
an actuator having a motor and being coupled to the brake, the actuator being operable to selectively apply and release the brake; and,
a controller coupled to the actuator and being operable to initialize the brake mechanism and apply a predetermined power level to the actuator, to establish motor stall and responsively determine a reference motor position, and to establish a home motor position as a function of the second position and a predetermined constant.

9. A brake mechanism, as set forth in claim 8, the controller further being operable to establish an initial motor position at initialization.

10. A brake mechanism, as set forth in claim 9, the controller further being operable to compare a difference between the initial position and the reference motor position and a predetermined minimum value and to generate a sigal if the difference is less than or equal to the predetermined minimum value.

11. A brake mechanism, as set forth in claim 10, the signal being indicative of a retained load condition.

12. A brake mechanism, as set forth in claim 8, the controller further being operable to store a predetermined number of previous home position values and to calculate an average home position.

13. A brake mechanism, as set forth in claim 8, the controller further being operable to define a target motor position to deliver a predetermined force through the brake as a function of at least one of the reference position and the home motor position and a second predetermined constant and generate command signals to the motor to move to the target position, to monitor the command signals, and if excessive, generate an error signal and, after the target position has been reached, to generate commands signals to the motor to move to the home position.

14. A brake mechanism, as set forth in claim 13, the controller further being operable to generate a confirmation signal when the home position has been reached.

15. A program product for calibrating a brake mechanism having a brake coupled to an actuator, the actuator having a motor, the actuator being controlled through rotations of the motor, comprising,
program code mesas for initializing the brake mechanism;
program code means for applying a predetermined power level to the actuator;
program code means for establishing motor stall and responsively determining a reference motor position; and,
program code means for establishing a home motor position as a function of the second position and a predetermined constant.

16. A program product, as set forth in claim 15, further comprising:
program code means for establishing an initial motor position at initialization;
program code means for comparing a difference between the initial position and the reference motor position and a predetermined minimum value; and,
program code means for generating a signal if the difference is less than or equal to the predetermined minimum value.

17. A program product, as set forth in claim 15, further comprising:
program code means for defining a ret motor position to deliver a predetermined force through the brake as a function of at least one of the reference position and the home motor position and a second predetermined constant;
program code means for generating command signals to the motor to move to the target position;
program code means for monitoring the command signals and if excessive generate an error signal; and,
program code means for, after the target position has been reached, generating commands signals to the motor to move to the home position.

18. (canceled)

19. (canceled)

20. (canceled)

21. (canceled)

22. (canceled)

23. (canceled)

24. (canceled)

25. (canceled)

26. (canceled)

27. (canceled)

28. (canceled)
